(19) United States
(12) Patent Application Publication
(10) Pub. No.: US 2021/0070127 A1
(43) Pub. Date: Mar. 11, 2021

(54) SHOCK ABSORBER

(71) Applicant: DRiV Automotive Inc., Lake Forest, IL (US)

(72) Inventor: Daniel Keil, Temprance, MI (US)

(21) Appl. No.: 16/561,652

(22) Filed: Sep. 5, 2019

(51) Int. Cl. B60G 17/018; B60G 17/015

(52) U.S. Cl. CPC B60G 17/0182; H04W 4/80; B60G 17/0152

(57) ABSTRACT

A frequency sensing system for a vehicle includes a shock absorber. The shock absorber has a frequency sensor configured to generate signals indicative of a shock frequency. The frequency sensing system includes a transmitter. The frequency sensing system includes an output device. The output device has a receiver for receiving the signals indicative of a shock frequency from the transmitter. One of the shock absorber and the output device is configured to compare the signals indicative of a shock frequency with a target frequency range. Further, the output device displays a notification when the shock frequency is outside of the target frequency range.

### TECHNICAL FIELD

The present disclosure generally relates to shock absorbers. More particularly, the present disclosure relates to an adjustable shock absorber.

### BACKGROUND

Vehicles generally include shock absorbers that are used in conjunction with suspension systems to absorb unwanted vibrations which occur while driving the vehicle. In order to absorb the vibrations, shock absorbers are generally connected between a body of the vehicle and the suspension system. Over a period of time, shock absorbers can lose their effectiveness, thereby impacting their damping characteristics. For example, when a damping force of the shock absorber reduces, a motion of the vehicle changes towards an undamped or vibratory motion. This undamped motion may cause damage to the suspension system, tires, and may also cause discomfort to a person seated in the vehicle.

When shock absorbers wear out or operate in a defective manner, it is advisable to either replace them with a new shock absorber or service them for improved vehicle performance. Shock absorbers are generally serviced periodically, however, in some cases, the shock absorbers may require servicing or replacement between two servicing schedules. Further, as the shock absorbers get older, some frequencies and/or vibrations can be disturbing to driver comfort or experience. Thus, it is may be advantageous to have a system that identifies such disturbing frequencies and/or vibrations that may be present during operation of the vehicle and generate an alert if the shock absorber needs servicing or replacement.

Given description covers one or more above mentioned problems and discloses a system to solve the problems.

### SUMMARY

In an aspect of the present disclosure, a shock absorber for a vehicle is provided. The shock absorber includes a shock frequency sensor configured to generate signals indicative of a shock frequency. The shock absorber also includes a controller communicably coupled with the shock frequency sensor. The controller is configured to receive the signals indicative of the shock frequency from the shock frequency sensor. The controller is also configured to compare the received signals with a target shock frequency range. The controller is further configured to adjust at least one operational parameter of the vehicle to prevent occurrence of the shock frequency outside of the target shock frequency range if the shock frequency is outside of the target shock frequency range.

In some embodiments, the controller adjusts the at least one operational parameter of the vehicle by sending an adjustment signal to the shock absorber.

In some embodiments, the controller sends the adjustment signal to the shock absorber through at least one of a Bluetooth device, a Wi-Fi network, and a Near Field Communication (NFC).

In some embodiments, the operational parameter is at least one of an operating pressure of the shock absorber, a stroke of the shock absorber, an operating fluid volume of the shock absorber, a vehicle ground clearance, and a tire pressure.

In some embodiments, adjusting of the at least one operational parameter includes replacing the shock absorber.

In another aspect of the present disclosure, a method of controlling a shock absorber for a vehicle is provided. The method includes receiving signals indicative of a shock frequency from a shock frequency sensor by a controller. The method also includes comparing the received signals with a target shock frequency range by the controller. The method further includes adjusting at least one operational parameter of the vehicle by the controller to prevent occurrence of the shock frequency outside of the target shock frequency range if the shock frequency is outside of the target shock frequency range.

In some embodiments, adjusting of the at least one operational parameter of the vehicle includes sending an adjustment signal to the shock absorber.

In some embodiments, the controller sends the adjustment signal to the shock absorber through at least one of a Bluetooth device, a Wi-Fi network, and a Near Field Communication (NFC).

In some embodiments, the operational parameter is at least one of an operating pressure of the shock absorber, a stroke of the shock absorber, an operating fluid volume of the shock absorber, a vehicle ground clearance, and a tire pressure.

In some embodiments, adjusting of the at least one operational parameter comprises replacing the shock absorber.

Other features and aspects of this disclosure will be apparent from the following description and the accompanying drawings.

### BRIEF DESCRIPTION OF DRAWINGS

FIG. 1 is an illustration of a vehicle incorporating a suspension system, according to an aspect of the present disclosure;

FIG. 2 is a perspective view of a shock absorber associated with the suspension system of FIG. 1, according to an aspect of the present disclosure;

FIG. 3 is a schematic view of monitoring system for the shock absorber of FIG. 2, according to an aspect of the present disclosure; and

FIG. 4 is a flowchart for a method of controlling the shock absorber for the vehicle, according to an aspect of the present disclosure.

### DETAILED DESCRIPTION

Wherever possible, the same reference numbers will be used throughout the drawings to refer to same or like parts.

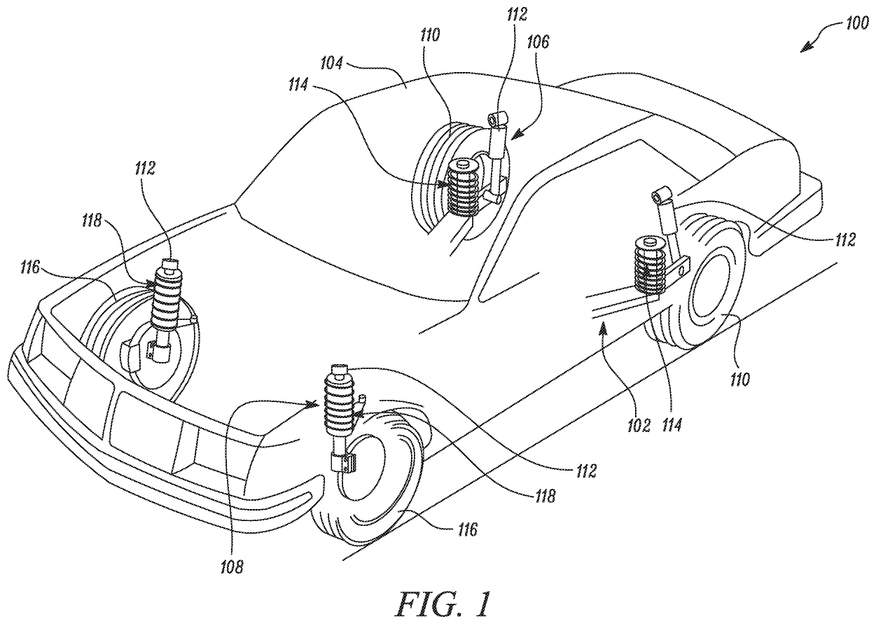

FIG. 1 illustrates an exemplary vehicle 100 incorporating a suspension system 102 in accordance with the present disclosure. The vehicle 100 may include a vehicle driven by an internal combustion engine, an electric vehicle, or a hybrid vehicle. The vehicle 100 includes a body 104. The suspension system 102 of the vehicle 100 includes a rear suspension 106 and a front suspension 108. The rear suspension 106 includes a transversely extending rear axle assembly (not shown) adapted to operatively support a pair of rear wheels 110. The rear axle assembly is operatively connected to the body 104 by means of a pair of shock absorbers 112 and a pair of helical coil springs 114. Similarly, the front suspension 108 includes a transversely extending front axle assembly (not shown) which operatively supports a pair of front wheels 116. The front axle assembly is operatively connected to the body 104 by means of another pair of the shock absorbers 112 and a pair of helical coil springs 118. In an alternative embodiment, the vehicle 100 may include an independent suspension unit (not shown) for each of the four corners instead of front and rear axle assemblies.

The shock absorbers 112 of the suspension system 102 serve to damp the relative movement of the unsprung portion (i.e., the front and rear suspensions 108, 106) and the sprung portion (i.e., the body 104) of the vehicle 100. While the vehicle 100 has been depicted as a passenger car, the shock absorbers 112 may be used with other types of vehicles. Examples of such vehicles include buses, trucks, off-road vehicles, and so forth. Furthermore, the term “shock absorber 112” as used herein will refer to dampers in general and will include McPherson struts and semi-active and active suspensions.

In some embodiments, a damping characteristic of each of the shock absorbers 112 is adjustable. In order to automatically adjust each of the shock absorbers 112, a control module (not shown) may be electrically connected to the shock absorbers 112. The control module may control an operation of each of the shock absorbers 112 in order to provide appropriate damping characteristics resulting from movements of the body 104 of the vehicle 100. Further, the control module may independently control each of the shock absorbers 112 in order to independently control a damping level of each of the shock absorbers 112. The control module may be electrically connected to the shock absorbers 112 via wired connections, wireless connections, or a combination thereof.

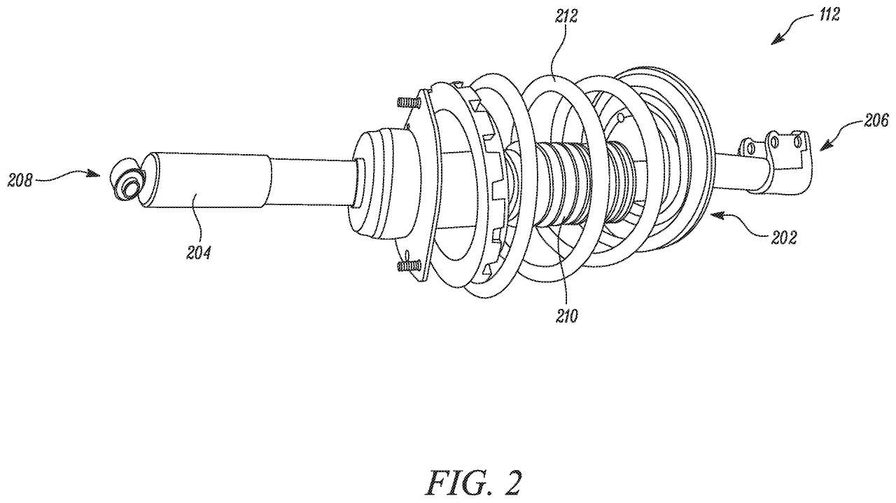

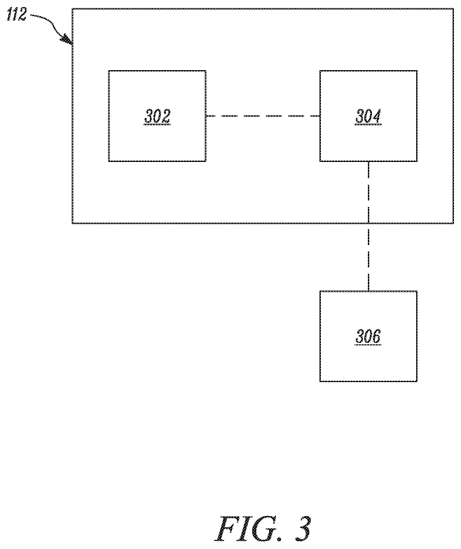

FIG. 2 illustrates a perspective view of the shock absorber 112, according to one embodiment of the present disclosure. The shock absorber 112 may be any of the four shock absorbers 112 of the vehicle 100. The shock absorbers 112 may include a Continuously Variable Semi-Active Suspension system (CVSA) shock absorber, without any limitations. A piston rod 204 (see FIG. 3) of the shock absorber 112 is coupled with the body 104 (see FIG. 1) of the vehicle 100 (see FIG. 1) and a shock absorber body 202 is coupled with the suspension system 102 (see FIG. 1). Further, the shock absorber 112 includes a first mounting arrangement 206 to connect the shock absorber body 202 with the suspension system 102. In one example, the first mounting arrangement 206 may include mechanical fasteners, such as bolts, screws, etc., that connect the shock absorber body 202 with the suspension system 102. Alternatively, the shock absorbers 112 may be mounted in an upside-down configuration, such as in high speed vehicles. More particularly, the shock absorber body 202 may be coupled with the body 104 and the piston rod 204 may be coupled with the suspension system 102. Additionally, a coil spring 212 is disposed around the shock absorber 112 to further isolate the body 104 from the suspension system 102.

The shock absorber 112 may contain a fluid which can be a hydraulic fluid or oil. The shock absorber 112 includes an outer tube (not shown) and an inner tube (not shown). The outer and inner tubes form a part of the shock absorber body 202. A piston (not shown) is slidably disposed within the inner tube. The shock absorber 112 also includes the piston rod 204. One end of the piston rod 204 is connected to the piston and reciprocates with the piston whereas another end of the piston rod 204 is connected to the body 104 of the vehicle 100. The piston rod 204 may be connected to the body 104 using a second mounting arrangement 208. The second mounting arrangement 208 may connect the piston rod 204 with the body 104 using mechanical fasteners, such as bolts, screws, etc. The shock absorber 112 also includes a dust tube 210. The dust tube 210 is a flexible tube having bellows such that the dust tube 210 can deform with the reciprocation of the piston rod 204. The dust tube 210 protects the piston rod 204 from dust, sand, water, or other contaminants.

The vehicle 100 is typically subjected to vibrations during operation. However, some frequency/vibrations may cause discomfort to a driver of the vehicle 100 and may affect driver comfort or experience. In some cases, such vibrations are present due to a faulty operation of the shock absorber 112, inappropriate vehicle ground clearance, or an insufficient tire pressure.

The shock absorber 112 is configured to monitor and identifies whether such disturbing frequencies or vibrations are present during operation of the vehicle 100. As shown in FIG. 3, the shock absorber 112 includes a shock frequency sensor 302. The shock frequency sensor 302 generates signals indicative of a shock frequency. In the illustrated example, the shock frequency sensor 302 generates signals corresponding to a shock frequency of the shock absorber 112. The shock frequency sensor 302 may be mounted in close proximity of the shock absorber 112, so that the shock frequency sensor 302 can measure the shock frequency of the shock absorber 112. The shock frequency sensor 302 may include any one of an accelerometer, a displacement sensor, an optical sensor, a magnetic sensor, an ultrasound sensor, and the like.

Further, the shock absorber 112 includes a controller 304. It should be noted that the controller 304 may be embodied as a separate component or functionalities of the controller 304 may be stored and processed by an Electronic Control Module (ECM) present on-board the vehicle 100, without any limitations. The controller 304 may embody a single microprocessor or multiple microprocessors for receiving signals from components of the vehicle 100. Numerous commercially available microprocessors may be configured to perform the functions of the controller 304. It should be appreciated that the controller 304 may embody a vehicle microprocessor capable of controlling numerous vehicle functions. A person of ordinary skill in the art will appreciate that the controller 304 may additionally include other components and may also perform other functions not described herein.

The controller 304 is communicably coupled with the shock frequency sensor 302. The controller 304 receives the signals indicative of the shock frequency from the shock frequency sensor 302. Further, the controller 304 compares the received signals with a target shock frequency range. More particularly, the controller 304 compares if the received signals lie within the target shock frequency range. The term “target shock frequency range” referred to herein may be defined as an allowable frequency range that includes frequency values at which the shock absorber 112 may oscillate or vibrate without causing excessive vibrations and driver discomfort.

Further, if the controller 304 detects that the shock frequency is outside of the target shock frequency range, the controller 304 adjusts at least one operational parameter of the vehicle 100 to prevent occurrence of the shock frequency. The operational parameter of the vehicle 100 disclosed herein may include any one of an operating pressure of the shock absorber 112, a stroke of the shock absorber 112, an operating fluid volume of the shock absorber 112, a vehicle ground clearance, a damping force of the shock absorber 112 or a tire pressure. Further, in one example, the operational parameter includes replacement of the shock absorber 112. For example, in some cases, the signals received from the shock frequency sensor 302 may be high enough to indicate that the shock absorber 112 requires replacement.

Further, when the operational parameter that needs to be adjusted pertains to the shock absorber 112, the controller 304 adjusts the operational parameter of the vehicle 100 by sending an adjustment signal to the shock absorber 112. The controller 304 sends the adjustment signal to the shock absorber 112 through a Bluetooth device, a Wi-Fi network, or a Near Field Communication (NFC). In other examples, wherein the controller 304 determines the operational parameter as the vehicle ground clearance or the tire pressure, the controller 304 may send an adjustment signal to the ECM of the vehicle 100 for varying the corresponding operational parameter. Accordingly, the controller 304 sends the adjustment signal to the ECM through the Bluetooth device, the Wi-Fi network, or the NFC, without any limitations.

In some examples, the controller 304 is communicably coupled to an output device 306 present in a driver cabin of the vehicle 100. The output device 306 may notify the driver that the shock frequency of the shock absorber 112 has exceeded the target shock frequency range by displaying a text message, a voice message, or by any other indicating means. In some examples, the output device 306 may flash an alert or notification for replacement of the shock absorber 112 or alternatively to alert a servicing personnel or the driver that one or more of the shock absorbers 112 need to be checked for servicing and/or replacement purposes.

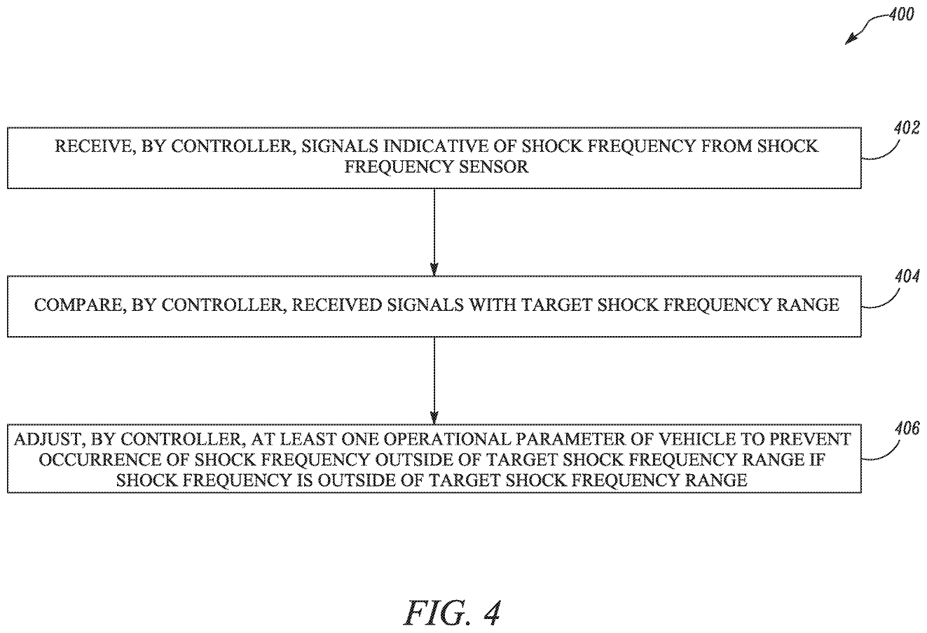

FIG. 4 illustrates a method 400 of controlling the shock absorber 112 for the vehicle 100. At step 402, the controller 304 receives the signals indicative of the shock frequency from the shock frequency sensor 302. At step 404, the controller 304 compares the received signals with the target shock frequency range. At step 406, the controller 304 adjusts the at least one operational parameter of the vehicle 100 to prevent occurrence of the shock frequency outside of the target shock frequency range if the shock frequency is outside of the target shock frequency range.

The operational parameter is at least one of the operating pressure of the shock absorber 112, the stroke of the shock absorber 112, the operating fluid volume of the shock absorber 112, the vehicle ground clearance, and the tire pressure. In one example, the control module adjusts the at least one operational parameter of the vehicle 100 by sending the adjustment signal to the shock absorber 112. In another example, adjustment of the at least one operational parameter includes replacement of the shock absorber 112. Further, the controller 304 sends the adjustment signal to the shock absorber 112 through the Bluetooth device, the Wi-Fi network, or the NFC.

Thus, the shock absorber 112 and the method 400 allows identification of any disturbing frequencies or vibrations that may be present during vehicle operation and accordingly sends out signals indicating that the one or more operational parameters of the vehicle 100 needs to be adjusted or the shock absorber 112 should be inspected or replaced, thereby assuring improved driver experience and smoother performance of the vehicle 100.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A shock absorber for a vehicle comprising:
a shock frequency sensor configured to generate signals indicative of a shock frequency;
a controller communicably coupled with the shock frequency sensor, the controller configured to:
receive the signals indicative of the shock frequency from the shock frequency sensor;
compare the received signals with a target frequency range; and
adjust at least one operational parameter of the vehicle to reduce occurrence of the shock frequency outside of the target frequency range.

2. The shock absorber of claim 1, wherein the controller adjusts the at least one operational parameter of the vehicle by sending an adjustment signal to the shock absorber.

3. The shock absorber of claim 2, wherein the controller sends the adjustment signal to the shock absorber through at least one of a Bluetooth device, a Wi-Fi network, and a Near Field Communication (NFC).

4. The shock absorber of claim 1, wherein the operational parameter is at least one of an operating pressure of the shock absorber, a stroke of the shock absorber, an operating fluid volume of the shock absorber, a vehicle ground clearance, a damping force of the shock absorber and a tire pressure.

5. The shock absorber of claim 1, wherein adjusting the at least one operational parameter comprises replacing the shock absorber.

6. The shock absorber of claim 1, wherein the controller is communicably coupled to an output device.

7. A method of controlling a shock absorber for a vehicle, the method comprising:
receiving, by a controller, signals indicative of a shock frequency from a shock frequency sensor;
comparing, by the controller, the received signals with a target shock frequency range; and
adjusting, by the controller, at least one operational parameter of the vehicle to prevent occurrence of the shock frequency outside of the target shock frequency range if the shock frequency is outside of the target shock frequency range.

8. The method of claim 7, wherein adjusting the at least one operational parameter of the vehicle comprises sending an adjustment signal to the shock absorber.

9. The method of claim 8, wherein the controller sends the adjustment signal to the shock absorber through at least one of a Bluetooth device, a Wi-Fi network, and a Near Field Communication (NFC).

10. The method of claim 7, wherein the operational parameter is at least one of an operating pressure of the shock absorber, a stroke of the shock absorber, an operating fluid volume of the shock absorber, a vehicle ground clearance, a damping force of the shock absorber and a tire pressure.

11. The method of claim 7, wherein adjusting the at least one operational parameter comprises replacing the shock absorber.

12. The method of claim 7, wherein the controller is communicably coupled to an output device.
